(19) United States
(12) Patent Application Publication
(10) Pub. No.: US 2018/0210275 A1
(43) Pub. Date: Jul. 26, 2018

(54) ELECTRONIC DISPLAY COMPONENT AND DISPLAY DEVICE

(71) Applicants: BOE Technology Group Co., Ltd., Beijing (CN); Beijing BOE Display Technology Co., Ltd., Beijing (CN)

(72) Inventor: Meili Wang, Beijing (CN)

(21) Appl. No.: 15/718,104

(22) Filed: Sep. 28, 2017

(30) Foreign Application Priority Data
Jan. 20, 2017 (CN) 201710051546.3

(51) Int. Cl. G02F 1/1335; G02F 1/1343

(52) U.S. Cl. CPC G02F 1/133504; G02F 1/13439

(57) ABSTRACT

The disclosure discloses an electronic display component and a display device so as to provide a color electronic-paper component to enable an image to be adjusted in color. The electronic display component includes a plurality of display elements which are arrayed, each of the display elements includes transmitting gratings on a transparent substrate, a photoelectric material in contact with the transmitting gratings, and a control part configured to control the refractive index of the photoelectric material, wherein the transmitting gratings are arranged at a sub-wavelength periodicity to transmit light corresponding to the sub-wavelength periodicity, wherein the material of the surface of each transmitting gratings is a metal material; and the control part is configured to adjust the refractive index of the photoelectric material according to received external voltage so that the light passing the transmitting gratings exits or is blocked.

### CROSS-REFERENCE TO RELATED APPLICATIONS

This application claims the priority to Chinese Patent Application No. 201710051546.3, filed on Jan. 20, 2017, the content of which is hereby incorporated by reference in its entirety.

### FIELD

The present disclosure relates to the field of display technologies, and particularly to an electronic display component and a display device.

### BACKGROUND

An electronic paper, also referred to as a digital paper, is an ultra-thin and ultra-light-weighted display screen. As illustrated in FIG. 1, the traditional electronic paper includes an upper substrate 13 and a lower substrate 14 arranged opposite to each other, and a display layer arranged between the upper substrate 13 and the lower substrate 14, and there are a plurality of display elements arrayed in the electronic paper, where the display layer in each display element includes black charged particles 12 and white charged particles 11; an upper electrode 15 is arranged on the upper substrate 13, and a lower electrode 16 is arranged on the lower substrate 14, and an electric field is created between the upper electrode 15 and the lower electrode 16 so that the black charged particles 12 and the white charged particles 11 keep on moving under the action of the electric field, where if the white charged particles 11 rise to the surface of the upper substrate 13, then light projected onto the surface of the upper substrate is completely reflected, thus resulting in a white state; and if the electric field is changed, then the black charged particles 12 and the white charged particles 11 may have their positions exchanged so that the white charged particles 11 drop, and the black charged particles 12 rise to the surface of the upper substrate 13, and then light projected onto the surface of the upper substrate 13 is completely absorbed by the black charged particles 12, thus resulting in a black state.

However the electronic paper on which only the white and black states can be displayed have become unsatisfactory to its consumers as the market of display devices is developing.

### SUMMARY

In view of this, embodiments of the disclosure provide an electronic display component and a display device so as to provide a color electronic-paper component to enable an image to be adjusted in color.

An embodiment of the disclosure provides an electronic display component including a plurality of display elements which are arrayed, each of the display elements includes transmitting gratings on a transparent substrate, a photoelectric material in contact with the transmitting gratings, and a control part configured to control the refractive index of the photoelectric material,
wherein: the transmitting gratings are arranged at a sub-wavelength periodicity to transmit light corresponding to the sub-wavelength periodicity, wherein the material of the surface of each transmitting gratings is a metal material; and
the control part is configured to adjust the refractive index of the photoelectric material according to received external voltage so that the light passing the transmitting gratings exits or is blocked.

An embodiment of the disclosure further provides a display device including the electronic display component above.

### BRIEF DESCRIPTION OF THE DRAWINGS

FIG. 1 is a schematic diagram of an operating principle of an electronic paper in the prior art;

FIG. 2 is a schematic structural diagram of an electronic display component according to an embodiment of the disclosure;

FIG. 3A is a schematic diagram of light being transmitted through a sub-wavelength silver hole;

FIG. 3B is a schematic diagram of a simulation result of the transmissivity through transmitting gratings in the electronic display component according to the embodiment of the disclosure;

FIG. 4 is a schematic structural diagram of another electronic display component according to an embodiment of the disclosure;

FIG. 5A is a schematic structural diagram of transmitting gratings arranged in the electronic display component to display in red according to the embodiment of the disclosure;

FIG. 5B is a schematic structural diagram of transmitting gratings arranged in the electronic display component to display in green according to the embodiment of the disclosure; and

FIG. 5C is a schematic structural diagram of transmitting gratings arranged in the electronic display component to display in blue according to the embodiment of the disclosure.

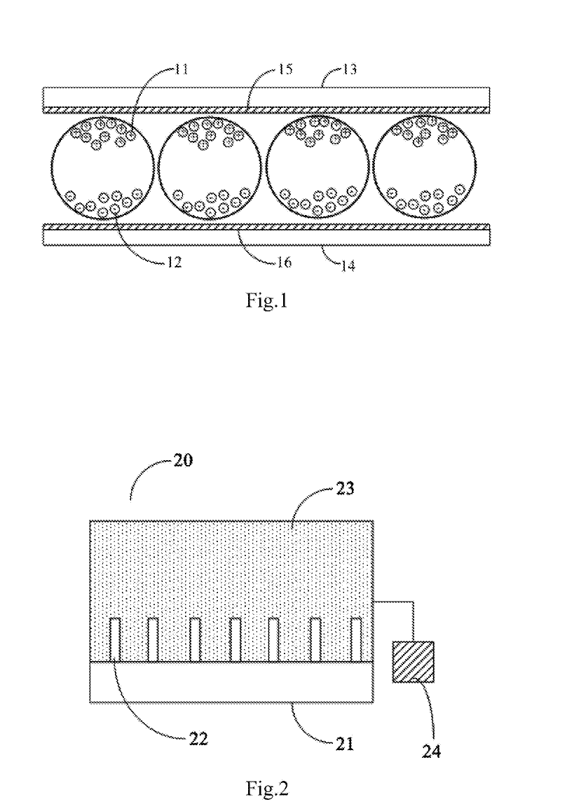

### DETAILED DESCRIPTION OF THE EMBODIMENTS

Embodiments of the disclosure provide an electronic display component and a display device so as to provide a color electronic-paper component to enable an image to be adjusted in color.

In order to make the objects, the technical solutions, and the advantages of the disclosure more apparent, the disclosure will be further described in details with reference to the drawings. Apparently the described embodiments are only a part but all of the embodiments of the disclosure. Based upon the embodiments here of the disclosure, all of other embodiments derived by those ordinarily skilled in the art without any inventive effort shall come into the scope of the disclosure.

An electronic display component according to particular embodiments of the disclosure will be described below in details with reference to the drawings.

As illustrated in FIG. 2, an embodiment of the disclosure provides an electronic display component including a plurality of display elements 20 which are arrayed, and each of the display elements 20 includes transmitting gratings 22 on a transparent substrate 21, a photoelectric material 23 in contact with the transmitting gratings 22, and a control part 24 configured to control the refractive index of the photoelectric material 23;

Where the transmitting gratings 22 are arranged at a sub-wavelength periodicity to transmit light corresponding to the sub-wavelength periodicity, where the material of the surface of each of the transmitting gratings 22 is a metal material; and

The control part 24 is configured to adjust the refractive index of the photoelectric material 23 according to received external voltage so that the light passing the transmitting gratings 22 exits or is blocked.

The transmitting gratings in a particular embodiment of the disclosure are arranged at the sub-wavelength periodicity, the material of the surface of each of the transmitting gratings 22 is a metal material, and the control part adjusts the refractive index of the photoelectric material in contact with the transmitting gratings according to the received external voltage so that the light passing the transmitting gratings exits or is blocked. As compared with the prior art, the refractive index of the photoelectric material in contact with the transmitting gratings is adjusted as a function of voltage in a particular embodiment of the disclosure, taking into account that transmitting gratings with a sub-wavelength periodicity have the characteristic of transmitting light at a specific wavelength, and this filtering characteristic thereof is very sensitive to the refractive index of a material in contact therewith, so that the transmitting gratings transmit light at the specific wavelength in a voltage operating state, but fail to transmit the light in another voltage operating stage, for the purpose of providing the color electronic-paper component to enable an image to be adjusted in color.

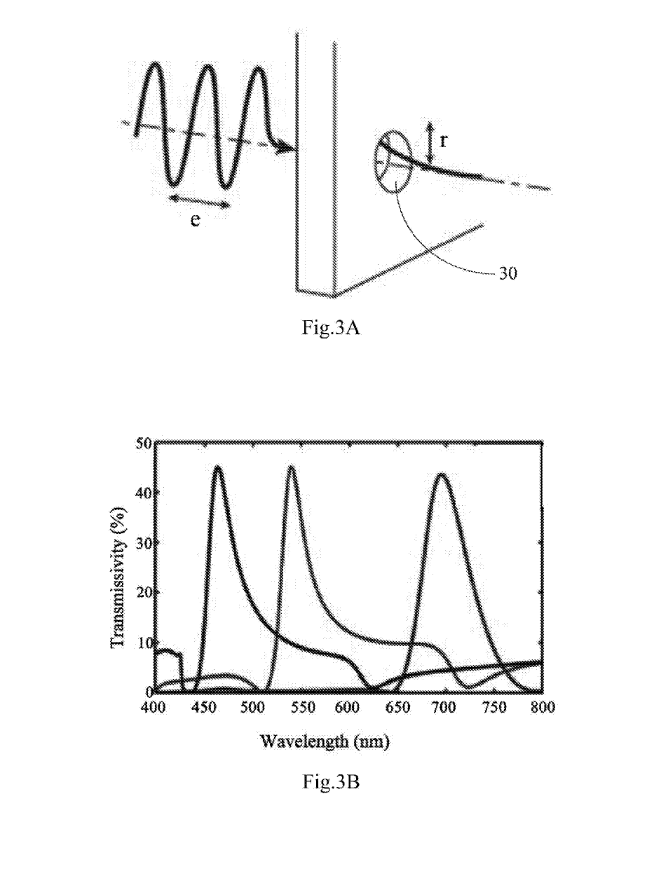

The characteristic of transmitting gratings with a sub-wavelength periodicity to transmit light at a specific wavelength will be described below in brief If the aperture size of a sub-wavelength metal hole is less than an incidence wavelength, then the photoelectric element may transmit light abnormally beyond the traditional optical diffraction limit. As illustrated in FIG. 3A, if light is projected onto a sub-wavelength periodicity silver (Ag) hole 30, then light at a specific wavelength among the incident light may resonate with plasma on the surface of the metal so that a part of the energy of a light wave is converted into vibration energy of free electrons, thus reflection is exponentially attenuated, and the energy-enhanced plasma is transmitted through the metal hole.

Particularly in a particular embodiment of the disclosure, the surface of each transmitting grating is a metal film layer; or the surface of each transmitting grating includes a metal film layer and an insulation medium film layer stacked over each other, where the metal film layer is located on the surface of the transmitting grating; or the surface of each transmitting grating includes a metal film layer, an insulation medium film layer, and a metal film layer stacked in that order. In a particular embodiment of the disclosure, the material of the surface of each transmitting grating is a metal material to enable photons to resonate with the plasma of the surface, and the light to be transmitted.

In a particular implementation, in a particular embodiment of the disclosure, the material of the metal film layer is one or a combination of aluminum (Al), silver (Ag), and gold (Au), and of course, the metal film layer can alternatively be made of another metal material, e.g., copper (Cu), in a real production process thereof, although the metal film layer will not be limited to any particular material in a particular embodiment of the disclosure.

Particularly in a particular embodiment of the disclosure, the periodicity T of each of the transmitting gratings satisfies the equation of:

λ=T*[(nₐ²*ϵₘ/(nₐ²+ϵₘ))^{1/2}−sin θ]/n,

Where λ represents a wavelength of red or green or blue light; θ represents the angle between light exiting a transmitting grating, and the plane where the transparent substrate lies; nₐ represents the refractive index of the photoelectric material; ϵₘ represents a dielectric constant of the metal material of the surface of the transmitting grating; and n represents a diffractive order.

FIG. 3B illustrates a simulation result of simulating the transmissivity of the transmitting grating designed in the equation above, and as can be apparent from the figure, light in the three primary colors of red (R), green (G), and blue (B) can be transmitted with a color gamut of greater than 85% in a particular embodiment of the disclosure, thereby satisfying a display application.

As can be apparent from the equation above, the wavelength of the transmitted light is very sensitive to the refractive index of the material of the surface in contact, so that the refractive index of the material of the surface of the grating can be controlled to let the light transmitted therethrough or not, where transmitting gratings with a sub-wavelength periodicity have the characteristics above of filtering and sensitivity to an ambient refractive index. In a particular embodiment of the disclosure, the refractive index of the photoelectric material in contact with the transmitting gratings can be controlled using the two characteristics of filtering and sensitivity to an ambient refractive index of the transmitting gratings to thereby provide the adjustable full-color electronic display.

Particularly in a particular embodiment of the disclosure, the photoelectric material is a liquid crystal material which can be selected more conveniently and easily. In a particular embodiment of the disclosure, the photoelectric material will not be limited to a liquid crystal material, but may alternatively be another material with a refractive index thereof variable with voltage.

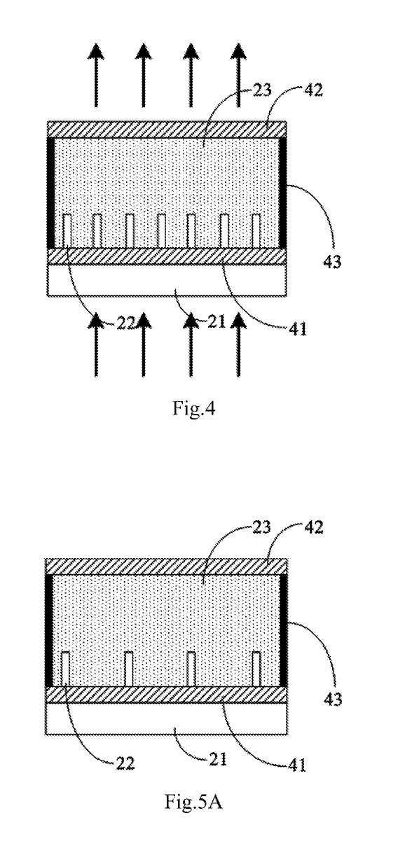

Particularly as illustrated in FIG. 4, in a particular embodiment of the disclosure, the control part includes a first transparent electrode 41 and a second transparent electrode 42 arranged opposite to each other, where the first transparent electrode 41 is located on the transparent substrate 21; and the photoelectric material 23 and the transmitting gratings 22 are located between the first transparent electrode 41 and the second transparent electrode 42. In a particular implementation, in a particular embodiment of the disclosure, the first transparent electrode 41 and the second transparent electrode 42 can enable each respective display element to be controlled separately, and in a particular embodiment of the disclosure, the first transparent electrode 41 and the second transparent electrode 42 can be a film of a single layer of indium tin oxide (ITO) or indium zinc oxide (IZO), or a film of two layers of ITO and IZO, and of course, they can alternatively be made of other transparent electrically-conductive material.

In a particular embodiment of the disclosure, the control part is arranged as the first transparent electrode 41 and the second transparent electrode 42 arranged opposite to each other, so that it will be more convenient and easier to product it in practice, and the first transparent electrode 41 and the second transparent electrode 42 arranged opposite to each other can better receive the external voltage, and adjust the refractive index of the photoelectric material according to the received external voltage. In FIG. 4, an arrow below the transparent substrate 21 represents the propagation direction of incident light rays, and an arrow above the transparent substrate 21 represents the propagation direction of the light rays exiting after passing the transmitting gratings 22 and the photoelectric material 23.

Particularly as illustrated in FIG. 4, in a particular embodiment of the disclosure, the electronic display component further includes a barrier layer 43 arranged between the first transparent electrode 41 and the second transparent electrode 42 to isolate the photoelectric material 23 in two adjacent display elements from each other, and the arrangement of the barrier layer 43 can well prevent a color crosstalk from occurring while the two adjacent display elements are displaying.

Particularly in a particular embodiment of the disclosure, the display elements are grouped into a plurality of groups of display elements, and each group of display elements includes three display elements including a first display element in which the transmitting gratings are configured to transmit red light, a second display element in which the transmitting gratings are configured to transmit green light, and a third display element in which the transmitting gratings are configured to transmit blue light; and in a particular implementation, in a particular embodiment of the disclosure, the size of an area in which each group of display elements is arranged may be the same as the size of an area of a pixel element on a liquid crystal display panel in the prior art, and the size of an area in which each display element is arranged may be the same as the size of a sub-pixel element on the liquid crystal display panel in the prior art.

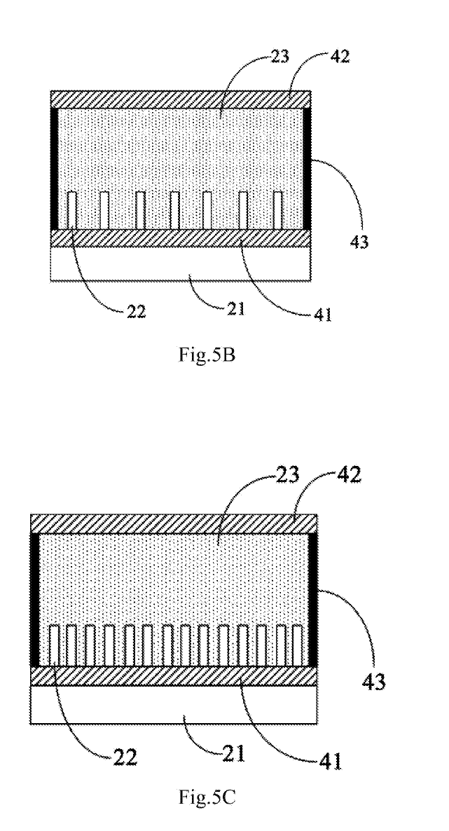

FIG. 5A illustrates a periodicity of the transmitting gratings 22 in the first display element, FIG. 5B illustrates a periodicity of the transmitting gratings 22 in the second display element, and FIG. 5C illustrates a periodicity of the transmitting gratings 22 in the third display element, where the periodicity of the transmitting gratings 22 in the first display element is greater than the periodicity of the transmitting gratings 22 in the second display element, and the periodicity of the transmitting gratings 22 in the second display element is greater than the periodicity of the transmitting gratings 22 in the third display element.

Particularly in a particular embodiment of the disclosure, the control part is configured to adjust the refractive index of the photoelectric material according to the received external voltage upon reception of the external voltage so that the light passing the transmitting gratings exits; and to adjust the refractive index of the photoelectric material when no external voltage is received so that the light passing the transmitting gratings 22 is blocked; or to adjust the refractive index of the photoelectric material according to the received external voltage upon reception of the external voltage so that the light passing the transmitting gratings 22 is blocked; and to adjust the refractive index of the photoelectric material when no external voltage is received so that the light passing the transmitting gratings 22 exits.

Displaying in the three primary colors of R, G, and B on the electronic display component according to the particular embodiment of the disclosure will be described below in brief with reference to FIG. 5A, FIG. 5B, and FIG. 5C.

In a particular embodiment of the disclosure, the control part will be described by way of example, which adjusts the refractive index of the photoelectric material according to the received external voltage upon reception of the external voltage so that the light passing the transmitting gratings exits; and adjusts the refractive index of the photoelectric material when no external voltage is received so that the light passing the transmitting gratings is blocked.

In a particular embodiment of the disclosure, the control part will be described by way of an example, which includes the first transparent electrode and the second transparent electrode arranged opposite to each other, and the photoelectric material will be described by way of an example, which is a liquid crystal material.

As illustrated in FIG. 5A, if red light is incident on the transparent substrate 21, then the transmitting gratings 22 may transmit the red light, and if the first transparent electrode 41 and the second transparent electrode 42 receive external voltage at this time, then the first transparent electrode 41 and the second transparent electrode 42 may adjust the refractive index of the liquid crystal material according to the received external voltage so that the light passing the transmitting gratings 22 can exit, where the electronic display component displays in red in FIG. 5A, and the magnitude of the external voltage in a particular embodiment of the disclosure can be set as needed in practice; and if the first transparent electrode 41 and the second transparent electrode 42 do not receive any external voltage, then the refractive index of the liquid crystal material may be restored to the original refractive index, and the condition of transmitting the light rays cannot be satisfied, so the light passing the transmitting gratings 22 cannot exit, where the electronic display component displays in black in FIG. 5A.

Alike as illustrated in FIG. 5B, if green light is incident on the transparent substrate 21, then the transmitting gratings 22 may transmit the green light, and if the first transparent electrode 41 and the second transparent electrode 42 receive external voltage at this time, then the first transparent electrode 41 and the second transparent electrode 42 may adjust the refractive index of the liquid crystal material according to the received external voltage so that the light passing the transmitting gratings 22 can exit, where the electronic display component displays in green in FIG. 5B; and if the first transparent electrode 41 and the second transparent electrode 42 do not receive any external voltage, then the refractive index of the liquid crystal material may be restored to the original refractive index, and the condition of transmitting the light rays cannot be satisfied, so the light passing the transmitting gratings 22 cannot exit, where the electronic display component displays in black in FIG. 5B.

Alike as illustrated in FIG. 5C, if blue light is incident on the transparent substrate 21, then the transmitting gratings 22 may transmit the blue light, and if the first transparent electrode 41 and the second transparent electrode 42 receive external voltage at this time, then the first transparent electrode 41 and the second transparent electrode 42 may adjust the refractive index of the liquid crystal material according to the received external voltage so that the light passing the transmitting gratings 22 can exit, where the electronic display component displays in blue in FIG. 5C; and if the first transparent electrode 41 and the second transparent electrode 42 do not receive any external voltage, then the refractive index of the liquid crystal material may be restored to the original refractive index, and the condition of transmitting the light rays cannot be satisfied, so the light passing the transmitting gratings 22 cannot exit, where the electronic display component displays in black in FIG. 5C.

Based upon the same inventive idea, a particular embodiment of the disclosure further provides a display device including the electronic display component according to the particular embodiments above of the disclosure, where the display device can be a liquid crystal TV set, an Organic Light Emitting Diode (OLED) TV set, an electronic paper, or another display device.

In summary, a particular embodiment of the disclosure provides an electronic display component including a plurality of display elements which are arrayed, each of the display elements includes transmitting gratings on a transparent substrate, a photoelectric material in contact with the transmitting gratings, and a control part configured to control the refractive index of the photoelectric material, where the transmitting gratings are arranged at a sub-wavelength periodicity to transmit light corresponding to the sub-wavelength periodicity, where the material of the surface of each transmitting grating is a metal material; and the control part is configured to adjust the refractive index of the photoelectric material according to received external voltage so that the light passing the transmitting gratings exits or is blocked. In a particular embodiment of the disclosure, the transmitting gratings are arranged at the sub-wavelength periodicity, and the material of the surface of each transmitting grating is a metal material; and the control part adjusts the refractive index of the photoelectric material in contact with the transmitting gratings according to the received external voltage so that the light passing the transmitting gratings exits or is blocked, so as compared with the prior art, the refractive index of the photoelectric material in contact with the transmitting gratings is adjusted as a function of voltage in a particular embodiment of the disclosure, taking into account that transmitting gratings with a sub-wavelength periodicity have the characteristic of transmitting light at a specific wavelength, and this filtering characteristic thereof is very sensitive to the refractive index of a material in contact therewith, so that the transmitting gratings transmit light at the specific wavelength in a voltage operating state, but fail to transmit the light in another voltage operating stage, for the purpose of providing the color electronic-paper component to enable an image to be adjusted in color.

Evidently those skilled in the art can make various modifications and variations to the disclosure without departing from the spirit and scope of the disclosure. Accordingly the disclosure is also intended to encompass these modifications and variations thereto so long as the modifications and variations come into the scope of the claims appended to the disclosure and their equivalents.

1. An electronic display component, comprising a plurality of display elements which are arrayed, each of the display elements comprises transmitting gratings on a transparent substrate, a photoelectric material in contact with the transmitting gratings, and a control part configured to control the refractive index of the photoelectric material, wherein:
the transmitting gratings are arranged at a sub-wavelength periodicity to transmit light corresponding to the sub-wavelength periodicity, wherein the material of the surface of each transmitting gratings is a metal material; and
the control part is configured to adjust the refractive index of the photoelectric material according to received external voltage so that the light passing the transmitting gratings exits or is blocked.

2. The electronic display component according to claim 1, wherein the control part comprises a first transparent electrode and a second transparent electrode arranged opposite to each other, and the first transparent electrode is located on the transparent substrate; and
the photoelectric material and the transmitting gratings are located between the first transparent electrode and the second transparent electrode.

3. The electronic display component according to claim 2, wherein the electronic display component further comprises a barrier layer arranged between the first transparent electrode and the second transparent electrode to isolate the photoelectric material in two adjacent display elements from each other.

4. The electronic display component according to claim 1, wherein the display elements are grouped into a plurality of groups of display elements, each group of display elements comprises three display elements comprising a first display element in which the transmitting gratings are configured to transmit red light, a second display element in which the transmitting gratings are configured to transmit green light, and a third display element in which the transmitting gratings are configured to transmit blue light; and
the periodicity of the transmitting gratings in the first display element is greater than the periodicity of the transmitting gratings in the second display element, and the periodicity of the transmitting gratings in the second display element is greater than the periodicity of the transmitting gratings in the third display element.

5. The electronic display component according to claim 1, wherein the periodicity of the transmitting gratings satisfies the equation of:
λ=T*[(nₐ²*ϵₘ/(nₐ²+ϵₘ))^{1/2}−sin θ]/n,
wherein λ represents a wavelength of red or green or blue light; θ represents an angle between light exiting each transmitting grating, and the plane where the transparent substrate lies; nₐ represents the refractive index of the photoelectric material; ϵₘ represents a dielectric constant of the metal material of the surface of the transmitting grating; and n represents a diffractive order.

6. The electronic display component according to claim 1, wherein the photoelectric material is a liquid crystal material.

7. The electronic display component according to claim 1, wherein the surface of each transmitting grating is a metal film layer; or
the surface of each transmitting grating comprises a metal film layer and an insulation medium film layer stacked over each other, wherein the metal film layer is located on the surface of the transmitting grating; or
the surface of each transmitting grating comprises a metal film layer, an insulation medium film layer, and a metal film layer stacked in that order.

8. The electronic display component according to claim 7, wherein the material of the metal film layer is one or a combination of aluminum, silver, and gold.

9. A display device, comprising an electronic display component, wherein the electronic display component comprises a plurality of display elements which are arrayed, each of the display elements comprises transmitting gratings on a transparent substrate, a photoelectric material in contact with the transmitting gratings, and a control part configured to control the refractive index of the photoelectric material, wherein:
the transmitting gratings are arranged at a sub-wavelength periodicity to transmit light corresponding to the sub-wavelength periodicity, wherein the material of the surface of each transmitting gratings is a metal material; and
the control part is configured to adjust the refractive index of the photoelectric material according to received external voltage so that the light passing the transmitting gratings exits or is blocked.

10. The display device according to claim 9, wherein the control part comprises a first transparent electrode and a second transparent electrode arranged opposite to each other, and the first transparent electrode is located on the transparent substrate; and
the photoelectric material and the transmitting gratings are located between the first transparent electrode and the second transparent electrode.

11. The display device according to claim 10, wherein the electronic display component further comprises a barrier layer arranged between the first transparent electrode and the second transparent electrode to isolate the photoelectric material in two adjacent display elements from each other.

12. The display device according to claim 9, wherein the display elements are grouped into a plurality of groups of display elements, each group of display elements comprises three display elements comprising a first display element in which the transmitting gratings are configured to transmit red light, a second display element in which the transmitting gratings are configured to transmit green light, and a third display element in which the transmitting gratings are configured to transmit blue light; and
the periodicity of the transmitting gratings in the first display element is greater than the periodicity of the transmitting gratings in the second display element, and the periodicity of the transmitting gratings in the second display element is greater than the periodicity of the transmitting gratings in the third display element.

13. The display device according to claim 9, wherein the periodicity of the transmitting gratings satisfies the equation of:
λ=T*[(nₐ²*ϵₘ/(nₐ²+ϵₘ))^{1/2}−sin θ]/n,
wherein λ represents a wavelength of red or green or blue light; θ represents an angle between light exiting each transmitting grating, and the plane where the transparent substrate lies; nₐ represents the refractive index of the photoelectric material; ϵₘ represents a dielectric constant of the metal material of the surface of the transmitting grating; and n represents a diffractive order.

14. The display device according to claim 9, wherein the photoelectric material is a liquid crystal material.

15. The display device according to claim 9, wherein the surface of each transmitting grating is a metal film layer; or
the surface of each transmitting grating comprises a metal film layer and an insulation medium film layer stacked over each other, wherein the metal film layer is located on the surface of the transmitting grating; or
the surface of each transmitting grating comprises a metal film layer, an insulation medium film layer, and a metal film layer stacked in that order.

16. The display device according to claim 15, wherein the material of the metal film layer is one or a combination of aluminum, silver, and gold.
